(19) United States
(12) Patent Application Publication
(10) Pub. No.: US 2026/0157516 A1
(43) Pub. Date: Jun. 11, 2026

(54) SCREW-FREE TABLE CAPABLE OF BEING MOUNTED EASILY AND QUICKLY

(71) Applicant: Zhejiang Yotrio Group Co., Ltd., Linhai (CN)

(72) Inventors: Fan Yang, Linhai (CN); Jianqiang Xie, Linhai (CN); Xianyu Zhang, Linhai (CN)

(73) Assignee: Zhejiang Yotrio Group Co., Ltd., Linhai (CN)

(21) Appl. No.: 19/263,681

(22) Filed: Jul. 9, 2025

(30) Foreign Application Priority Data
Dec. 5, 2024 (CN) 202422991076.7

(51) Int. Cl. A47B 13/00; A47B 13/02; F16B 12/10

(52) U.S. Cl. CPC A47B 13/003; A47B 13/021; F16B 12/10

(57) ABSTRACT

A screw-free table capable of being mounted easily and quickly, including a table leg assembly and a table top assembly, where the table leg assembly includes a first table leg group and a second table leg group, the first table leg group and the second table leg group are matched in an inserted manner, elastic button assemblies are disposed at the top of the first table leg group and the top of the second table leg group, and the elastic button assemblies are movably snap-fitted with C-shaped pipes disposed at the bottom of the table top assembly. The first table leg group and the second table leg group are assembled in an inserted manner, and the first table leg group and the second table leg group are matched with the table top assembly by means of the elastic button assemblies. Through such design, the table has a few components, has a stable structure, and can be quickly mounted and dismounted without tools.

### CROSS-REFERENCE TO RELATED APPLIATIONS

The application claims priority to Chinese Application No. 202422991076.7, filed on Dec. 5, 2024, the entire content of which is incorporated herein by reference.

### TECHNICAL FIELD

The present disclosure belongs to the technical field of applications of living furniture, and particularly relates to a screw-free table capable of being mounted easily and quickly.

### BACKGROUND

To facilitate transport and reduce boxes, tables will adopt the easily assembling and disassembling design, table tops and table legs of furniture are fixed through screws and stop pieces. The main defects lie in that tools are needed when the table tops and the table legs are fixed through the screws, there are many parts, the assembling process wastes time and labor, a certain amount of screws are needed to ensure the stability and strength of the tables, and slippage phenomena occur after repeated assembling and disassembling of the screws, so that the whole products cannot be used, and the experience of customers is poor.

According to the present application, to meet the increasing demand of users for the quality of the products, aiming at the defects, the conventional dining tables are improved and optimized, and the table having a few parts and capable of being assembled quickly without tools is provided.

### SUMMARY

To overcome the defects in the prior art, the present disclosure provides a screw-free table capable of being mounted easily and quickly.

The screw-free table capable of being mounted easily and quickly includes a table leg assembly and a table top assembly, where the table leg assembly includes a first table leg group and a second table leg group, the first table leg group and the second table leg group are matched in an inserted manner, elastic button assemblies are disposed at the top of the first table leg group and the top of the second table leg group, and the elastic button assemblies are movably snap-fitted with C-shaped pipes disposed at the bottom of the table top assembly.

Further, the first table leg group and the second table leg group are distributed orthogonally; the first table leg group includes two first support rods disposed symmetrically, middle portions of the first support rods on two sides are connected by means of a first transverse rod, a shaft pin is disposed in the middle of an upper end surface of the first transverse rod, and a first positioning pipe matched with the C-shaped pipe is disposed at the top of each of the first support rods.

Further, each of the first positioning pipes is parallel to the first transverse rod.

Further, the second table leg group includes two second support rods disposed symmetrically, middle portions of the second support rods on two sides are connected by means of a second transverse rod, a shaft sleeve is disposed in the middle of a lower end surface of the second transverse rod and is configured to be matched with the shaft pin in an inserted manner, and a second positioning pipe matched with the C-shaped pipe is disposed at the top of each of the second support rods.

Further, each of the second positioning pipes is parallel to the second transverse rod.

Further, the elastic button assemblies are disposed inside the first positioning pipes and the second positioning pipes; each of the elastic button assemblies includes a V-shaped elastic button; the V-shaped elastic buttons are inserted into the first positioning pipes and the second positioning pipes; and plugs are disposed on the first positioning pipes and the second positioning pipes to position the V-shaped elastic buttons.

Further, the table top assembly includes a table top frame, a table top plate is disposed on the table top frame, a cross frame is disposed inside the table top frame, and the C-shaped pipes are disposed on a lower end surface of the cross frame.

Further, leg pads are disposed at the bottoms of the first support rods and the second support rods.

Compared with the prior art, the present disclosure has the following advantages: according to the present disclosure, the first table leg group and the second table leg group are assembled in an inserted manner, and the first table leg group and the second table leg group are matched with the table top assembly by means of the elastic button assemblies. Through such design, the table has a few components, has a stable structure, and can be quickly mounted and dismounted without tools.

### BRIEF DESCRIPTION OF THE DRAWINGS

FIG. 1 is a structural schematic diagram of a table in the present disclosure;

FIG. 2 is an exploded schematic diagram of a table in the present disclosure; and

FIG. 3 is a schematic diagram of a table leg assembly in the present disclosure.

In the drawings: 1—table leg assembly, 11—first table leg group, 111—first support rod, 112—first transverse rod, 113—shaft pin, 12—second table leg group, 121—second support rod, 122—second transverse rod, 123—shaft sleeve, 2—table top assembly, 21—table top frame, 22—table top plate, 23—cross frame, 3—elastic button assembly, 31—V-shaped elastic button, 32—plug, 4—C-shaped pipe, 5—first positioning pipe, and 6—second positioning pipe.

### DETAILED DESCRIPTION OF EMBODIMENTS

In order to make the purposes, technical solutions and advantages of the present disclosure clearer, the present disclosure is further described in detail in conjunction with accompanying drawings and embodiments below. It should be understood that the specific embodiments described herein are only used to explain the present disclosure, not to define the present disclosure.

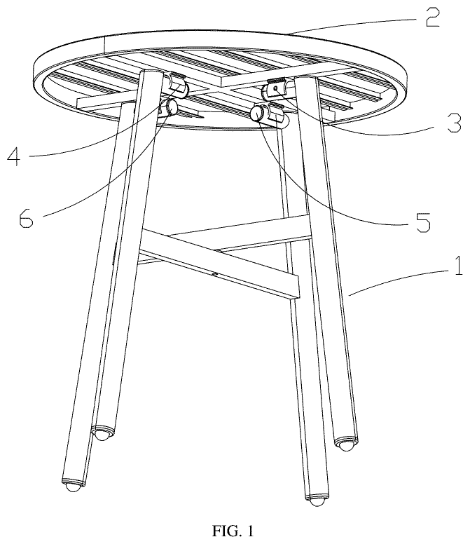

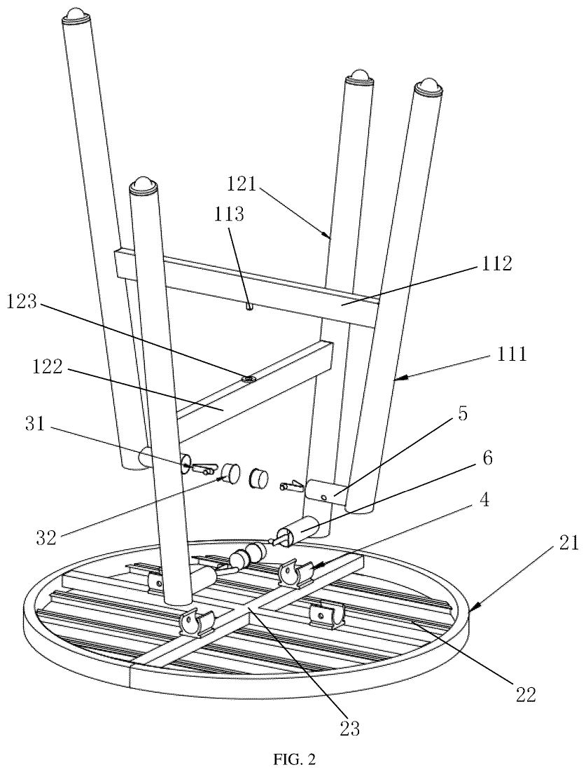

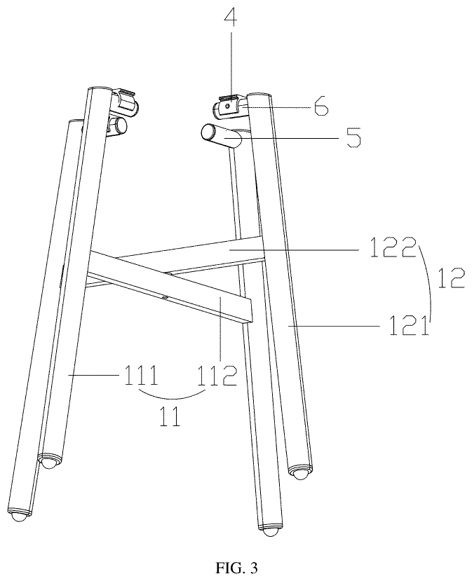

As shown in FIG. 1-FIG. 3, a screw-free table capable of being mounted easily and quickly includes a table leg assembly 1 and a table top assembly 2, where the table leg assembly 1 includes a first table leg group 11 and a second table leg group 12, the first table leg group 11 and the second table leg group 12 are matched in an inserted manner, elastic button assemblies 3 are disposed at the top of the first table leg group 11 and the top of the second table leg group 12, and the elastic button assemblies 3 are movably snap-fitted with C-shaped pipes 4 disposed at the bottom of the table top assembly 2.

Specifically, the first table leg group 11 and the second table leg group 12 are distributed orthogonally; the first table leg group 11 includes two first support rods 111 disposed symmetrically, middle portions of the first support rods 111 on two sides are connected by means of a first transverse rod 112, a shaft pin 113 is disposed in the middle of an upper end surface of the first transverse rod 112, a first positioning pipe 5 matched with the C-shaped pipe 4 is disposed at the top of each of the first support rods 111, and the first positioning pipe 5 is parallel to the first transverse rod 112. The second table leg group 12 includes two second support rods 121 disposed symmetrically, middle portions of the second support rods 121 on two sides are connected by means of a second transverse rod 122, a shaft sleeve 123 is disposed in the middle of a lower end surface of the second transverse rod 122 and is configured to be matched with the shaft pin 113 in an inserted manner, a second positioning pipe 6 matched with the C-shaped pipe 4 is disposed at the top of each of the second support rods 121, and the second positioning pipe 6 is parallel to the second transverse rod 122. Leg pads are disposed at the bottoms of the first support rods 111 and the second support rods 121.

In the present application, the elastic button assemblies 3 are disposed inside the first positioning pipes 5 and the second positioning pipes 6; each of the elastic button assemblies 3 includes a V-shaped elastic button 31; the V-shaped elastic buttons 31 are inserted into the first positioning pipes 5 and the second positioning pipes 6 (that is, elastic button holes are formed in the first positioning pipes 5 and the second positioning pipes 6, and button columns of the V-shaped elastic buttons 31 can slide into and out of the elastic button holes); and plugs 32 are disposed on the first positioning pipes 5 and the second positioning pipes 6 to position the V-shaped elastic buttons 31, thereby preventing the V-shaped elastic buttons 31 from falling out of the first positioning pipes 5 and the second positioning pipes 6.

Besides, the table top assembly 2 includes a table top frame 21, a table top plate 22 is disposed on the table top frame 21, a cross frame 23 is disposed inside the table top frame 21, and the C-shaped pipes 4 are disposed on a lower end surface of the cross frame 23. Through holes are formed in positions of the C-shaped pipes 4 corresponding to the elastic button holes in the first positioning pipes 5 and the second positioning pipes 6, and the button columns of the V-shaped elastic buttons 31 can slide into and out of the through holes, thereby achieving the assembling of the C-shaped pipes 4 with the first positioning pipes 5 and the second positioning pipes 6.

It is understandable that in the present application, the first table leg group 11, the second table leg group 12 and the table top assembly 2 are limited by means of the V-shaped elastic buttons 31 and the C-shaped pipes 4, and the first table leg group 11 and the second table leg group 12 cross each other and are limited through matching of the shaft pin 113 with the shaft sleeve 123. That is, through the matching of the C-shaped pipes 4 with the V-shaped elastic buttons 31, the table leg assembly 1 can be quickly and movably snap-fitted with the table top assembly 2.

During mounting, the V-shaped elastic buttons 31 of the first table leg group 11 are pressed to be inserted into C-shaped clamping members 3 until the V-shaped elastic buttons 31 pop out of the through holes in the C-shaped pipes 4, the mounting step of the second table leg group 12 is completed in the same way, and meanwhile, the shaft pin 113 of the first table leg group 11 is aligned to the shaft sleeve 123 of the second table leg group 12 to complete the assembling. During disassembling, the V-shaped elastic buttons 31 can be pressed to pull out the first table leg group 11 and the second table leg group 12 respectively, and the table can be assembled and disassembled conveniently without tools.

Finally, it should be noted that the above embodiments are only for illustrating the technical solutions of the present disclosure, and are not limitations; although the present disclosure is illustrated in detail with reference to the above-mentioned embodiments, those of ordinary skill in the art should understand that they can still amend the technical solutions recited in the above-mentioned embodiments, or perform equivalent substitutions on part or all of the technical features thereof; and such amendments or substitutions do not make the essence of the corresponding technical solutions depart from the scope of the technical solutions of the embodiments of the present disclosure.

What is claimed is:

1. A screw-free table capable of being mounted easily and quickly, comprising a table leg assembly and a table top assembly, wherein the table leg assembly comprises a first table leg group and a second table leg group, the first table leg group and the second table leg group are matched in an inserted manner, elastic button assemblies are disposed at the top of the first table leg group and the top of the second table leg group, and the elastic button assemblies are movably snap-fitted with C-shaped pipes disposed at the bottom of the table top assembly.

2. The screw-free table capable of being mounted easily and quickly according to claim 1, wherein the first table leg group and the second table leg group are distributed orthogonally; the first table leg group comprises two first support rods disposed symmetrically, middle portions of the first support rods on two sides are connected by means of a first transverse rod, a shaft pin is disposed in the middle of an upper end surface of the first transverse rod, and a first positioning pipe matched with the C-shaped pipe is disposed at the top of each of the first support rods.

3. The screw-free table capable of being mounted easily and quickly according to claim 2, wherein each of the first positioning pipes is parallel to the first transverse rod.

4. The screw-free table capable of being mounted easily and quickly according to claim 2, wherein the second table leg group comprises two second support rods disposed symmetrically, middle portions of the second support rods on two sides are connected by means of a second transverse rod, a shaft sleeve is disposed in the middle of a lower end surface of the second transverse rod and is configured to be matched with the shaft pin in an inserted manner, and a second positioning pipe matched with the C-shaped pipe is disposed at the top of each of the second support rods.

5. The screw-free table capable of being mounted easily and quickly according to claim 4, wherein each of the second positioning pipes is parallel to the second transverse rod.

6. The screw-free table capable of being mounted easily and quickly according to claim 4, wherein the elastic button assemblies are disposed inside the first positioning pipes and the second positioning pipes; each of the elastic button assemblies comprises a V-shaped elastic button; the V-shaped elastic buttons are inserted into the first positioning pipes and the second positioning pipes; and plugs are disposed on the first positioning pipes and the second positioning pipes to position the V-shaped elastic buttons.

7. The screw-free table capable of being mounted easily and quickly according to claim 1, wherein the table top assembly comprises a table top frame, a table top plate is disposed on the table top frame, a cross frame is disposed inside the table top frame, and the C-shaped pipes are disposed on a lower end surface of the cross frame.

8. The screw-free table capable of being mounted easily and quickly according to claim 4, wherein leg pads are disposed at the bottoms of the first support rods and the second support rods.
